(19) United States
(12) Patent Application Publication
(10) Pub. No.: US 2008/0223091 A1
(43) Pub. Date: Sep. 18, 2008

(54) CABINET-STYLE LOCK BOX HAVING A LOCKING MECHANISM

(76) Inventors: John W. Kroening, Rockford, IL (US); Louis George Boss, Floyds Knobs, IN (US)

Correspondence Address: TREXLER, BUSHNELL, GIANGIORGI, BLACKSTONE &;MARR, LTD., 105 W. ADAMS STREET, SUITE 3600, CHICAGO, IL, 60603, US

(21) Appl. No.: 12/046,179

(22) Filed: Mar. 11, 2008

Related U.S. Application Data
(60) Provisional application No. 60/918,510, filed on Mar. 16, 2007.

(51) Int. Cl. E05B 65/44

(52) U.S. Cl. 70/78

(57) ABSTRACT

A locking mechanism includes a lock and first and second movable members. The lock has a body and a shank, but does not have an exposed shackle. The body defines a slot which opens to an outward surface thereof. The shank is movable within the body between a locked position where the shank is within the slot and an unlocked position where the shank is not within the slot. The second member is disposed within the slot of the lock and is operatively associated with the first member. In operation, when the shank is in the locked position, the shank prevents the second member from moving within the slot of the lock, thus substantially preventing the first member from moving. When the shank is in the unlocked position, the second member is able to freely move within the slot of the lock, thus allowing the first member to move.

### CROSS-REFERENCE AND INCORPORATION BY REFERENCE

This application claims the domestic benefit of U.S. Provisional Application Ser. No. 60/918,510 filed on Mar. 16, 2007, which disclosure is hereby incorporated by reference in its entirety.

### BACKGROUND OF THE INVENTION

Lock or gang boxes are commonly used by contractors in the construction industry to provide a secure place to store tools safely overnight, or during other periods when the contractors are not present to prevent others from taking their tools. These lock boxes typically use padlocks that are part of a locking mechanism which keeps the lid of the box closed and prevents opening of the lid after the tools have been placed within the box and the padlock has been locked. Frequently, the padlock is situated within a pocket such that its body only partially protrudes therefrom, even when the padlock is in an open configuration, and the shackle is substantially inaccessible at all times, preventing someone from cutting the shank with bolt cutters.

A disadvantage that many lock boxes have is that they use padlocks as part of their locking mechanism. These padlocks often have a key tumbler that is made of brass and even if the shackle cannot be cut using bolt cutters, the lock box can be broken into by drilling out the tumbler portion of the padlock, rendering the padlock incapable of locking the box. Accordingly, there still exists a need for a lock box that uses a lock that cannot be easily tampered with, thereby preventing someone from breaking into the lock box.

Another disadvantage that many lock boxes have is that the lock boxes have a horizontal configuration with a lid that rotates about a horizontal axis, see U.S. Pat. Nos. 6,772,613; 6,209,739; and 6,464,095. Although this configuration helps to maximize the number of items that can be stored in the lock box, the horizontal nature also requires that the user stoop and bend over while taking items out of the box, which could lead to back strain. This can be undesirable especially when trying to access heavy equipment and tools that are typically stored in such boxes. Furthermore, organizing the contents of such boxes so that the user can quickly find a specific item can be a challenge.

Accordingly, there exists a need for a lock box that uses a lock that cannot be easily tampered with, preventing someone from breaking into the lock box, and that has a configuration that more readily facilitates the organization and extraction of items that are in the lock box.

### SUMMARY OF THE INVENTION

Briefly, the present invention provides a lock box having a locking mechanism. The locking mechanism includes a lock and first and second movable members. The lock has a body and a shank, but does not have an exposed shackle. In a preferred embodiment, the lock is a puck lock. The body defines a slot which is open to an outward surface of the body. The shank is configured to be movable within the body between a locked position where the shank is disposed within the slot and an unlocked position where the shank is not disposed within the slot. The second movable member is at least partially disposed within the slot of the lock. The second movable member is operatively associated with the first movable member.

In operation, when the shank is in the locked position, the shank prevents the second movable member from moving within the slot of the lock, thus substantially preventing the first movable member from moving. When the shank is in the unlocked position, the second movable member is able to freely move within the slot of the lock, thus allowing the first movable member to move.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a lock box with a locking mechanism that is in an unlocked configuration with a door opened;

FIG. 2 is a perspective view of the lock box with the doors closed and the locking mechanism in a locked configuration;

FIG. 3 is an enlarged, partial front elevational view of the lock box with the locking mechanism in a locked configuration;

FIG. 4 is a perspective view of the locking mechanism removed from the lock box and without the flanges;

FIG. 5 is a top plan view of the locking mechanism rotated at a slight angle;

FIG. 6 is an enlarged rear perspective view of the lock box with the top and rear panels removed, and showing the locking mechanism in a locked configuration;.

FIG. 7 is a rear plan view of the locking mechanism in the lock box;

FIG. 8 is an enlarged perspective view of the lock box with the locking mechanism, right door, and a section of the front panel removed showing how the locking mechanism operates when being unlocked;

FIG. 9 is an enlarged, front, partial perspective view of the lock box, with a portion thereof being cutaway to show the locking mechanism in an unlocked configuration, and with the lock and the lock housing shown in cross-section;

FIG. 10 is a perspective view of the lock box showing the locking mechanism in a locked configuration;

FIG. 11 is an enlarged, front, partial perspective view of the lock box, with a portion thereof being cutaway to show the locking mechanism in a locked configuration, and with the lock and the lock housing shown in cross-section:

FIG. 12 is a front, partial elevational view of the lock box, with a portion thereof being cutaway to show the locking mechanism in a locked configuration with some components thereof being shown in phantom lines, and with the lock and the lock housing shown in cross-section;

FIG. 13 is a perspective view of the lock in an unlocked configuration;

FIG. 14 is a rear perspective view of the lock in an unlocked configuration;

FIG. 15 is a perspective view of the lock in a locked configuration;

FIG. 16 is rear perspective view of the lock in the locked configuration;

FIG. 17 is a perspective view of a U-shaped guide bracket of the locking mechanism;

FIG. 18 is an exploded assembly view showing how the locking mechanism is assembled and attached to the lock box with the lock and electrical access cover removed;

FIG. 19A is a side elevational view of an alternate locking mechanism where the lock is rotated ninety degrees with the longitudinal slot being aligned in a substantially vertical direction;

FIG. 19B is a cross-sectional view of the alternate locking mechanism taken along line 19B-19B of FIG. 19A, which illustrates a pin of the locking mechanism being unable to substantially move with a shank of the lock in a locked configuration; and

FIG. 19C is a cross-sectional view similar to FIG. 19B, except illustrating the pin of the locking mechanism being free to move with the shank of the puck in an unlocked configuration.

### DETAILED DESCRIPTION OF THE PREFERRED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

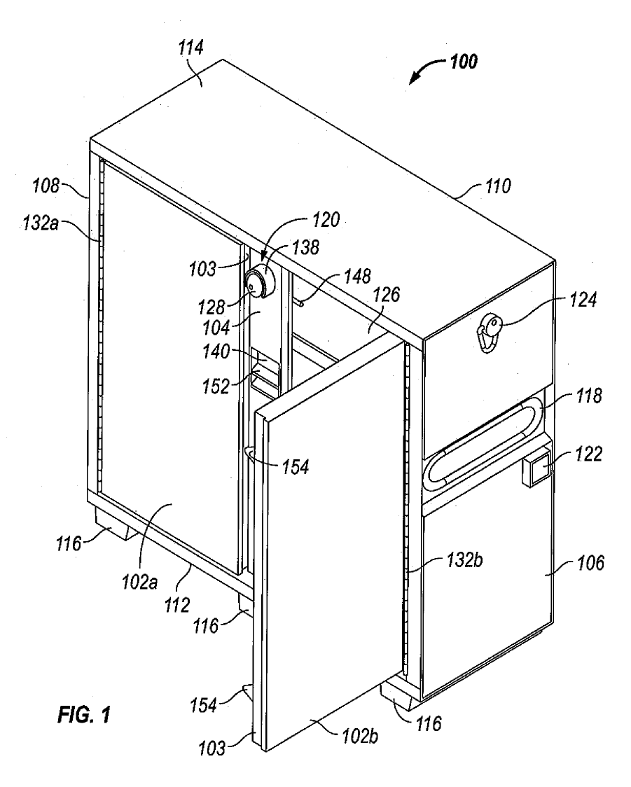

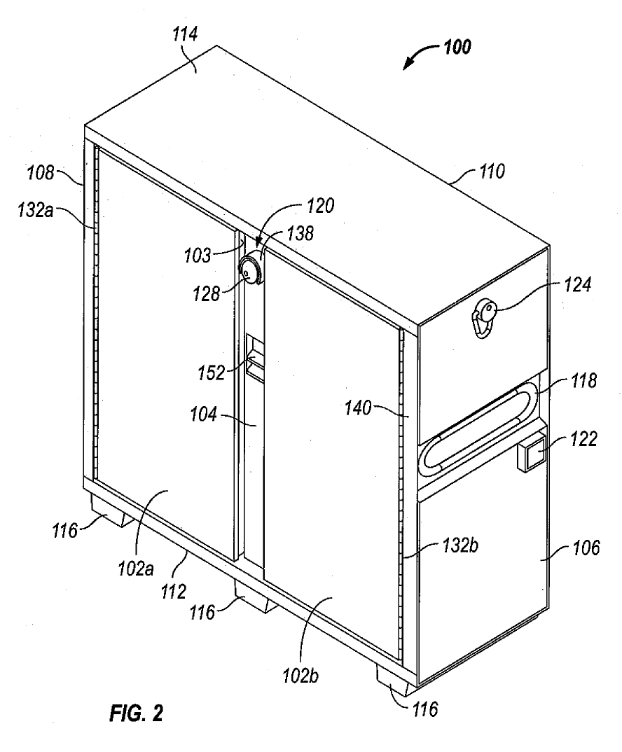

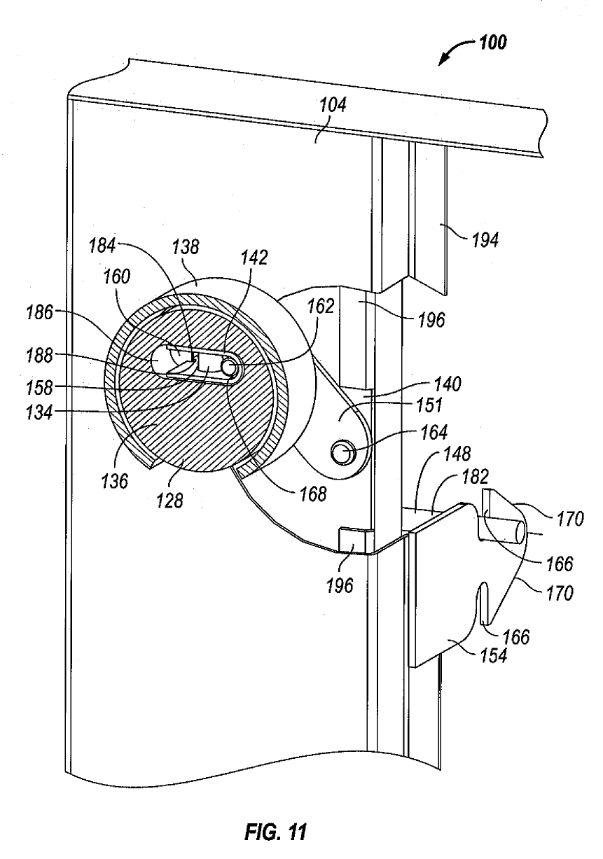

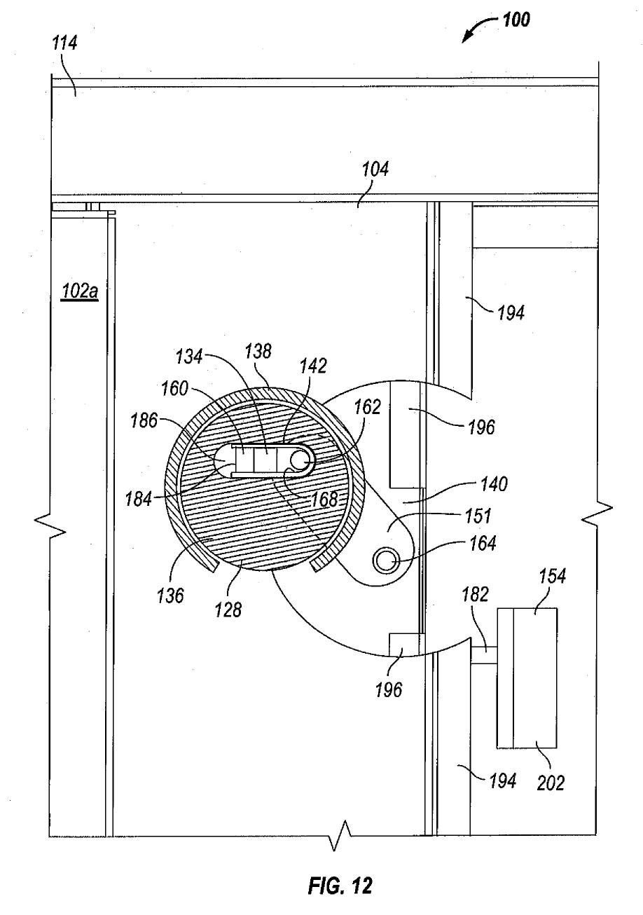

The preferred embodiment of a lock box 100 of a vertical or cabinet style nature that satisfies the aforementioned needs is shown in FIGS. 1 and 2. The lock box 100 includes, in part, left and right doors 102a, 102b, a front panel 104, a right side panel 106, a left side panel 108, a back panel 110, a bottom panel 112 and a top panel 114, each of which are preferably formed from metal. The top panel 114 connects the front panel 104 to the back panel 110, and connects the right side panel 106 to the left side panel 108. The front panel 104 connects the top panel 114 to the bottom panel 112. The front panel 104 is a U-shaped channel that has tabs 194 extending outwardly from its sides. The front panel 104 is not directly connected to the right side panel 106 or the left side panel 108. The back panel 110 also connects the top panel 114 to the bottom panel 112, and connects the right side panel 106 to the left side panel 108. An elongated horizontal slot 184, as best illustrated in FIGS. 11 and 12, is provided through the front panel 104 proximate to the top edge thereof.

The left door 102a is pivotally attached to the left side panel 108 by a vertical hinge 132a; the right door 102b is pivotally attached to the right side panel 106 by a vertical hinge 132b. A finger slot 103 is provided on the free end of each door 102a, 102b. The doors 102a, 102b and panels 104, 106, 108, 110, 112, 114 define a cavity within the lock box 100.

Horizontal shelves 126 are provided within the cavity so that the user can place items easily into the lock box 100 or remove items from the lock box 100. FIG. 1 shows the lock box 100 in an open configuration allowing the user to place items onto the shelves 126 that are each dedicated to a certain type of tool for example, easing organization, while also minimizing the amount of bending or stooping the user must do in order to put items into or take items out of the lock box 100, thereby reducing the possibility of back strain or other types of injury. When the doors 102a, 102b are closed, the cavity is concealed.

Spaced apart skids 116 are attached to the bottom surface of the bottom panel 112. A handle 118 and a lifting ring 124 are attached to each side panel 106, 108. One of the handles (not shown) is attached near the top of the exterior of the left panel 108, and the other handle 118 is attached near the top of the exterior of the right panel 106. Each lifting ring 124 is located above the respective side handle 118. An electrical access cover 122 is provided on at least one of the panels, and as shown, is provided on the right side panel 106. The electrical access cover 122 can be flipped out of the way so that an electrical cord can pass through it, providing power for any equipment that is located within the lock box 100.

A locking mechanism 120 is provided on the front panel 104. The locking mechanism 120 includes a lock 128, a skirt or housing 138, a movable panel 140, a U-shaped guide bracket 142, set screws 144, spacer plates 146, locking bars 148, a pivot arm assembly 150, a handle 152, flanges 154 and a sleeve 192.

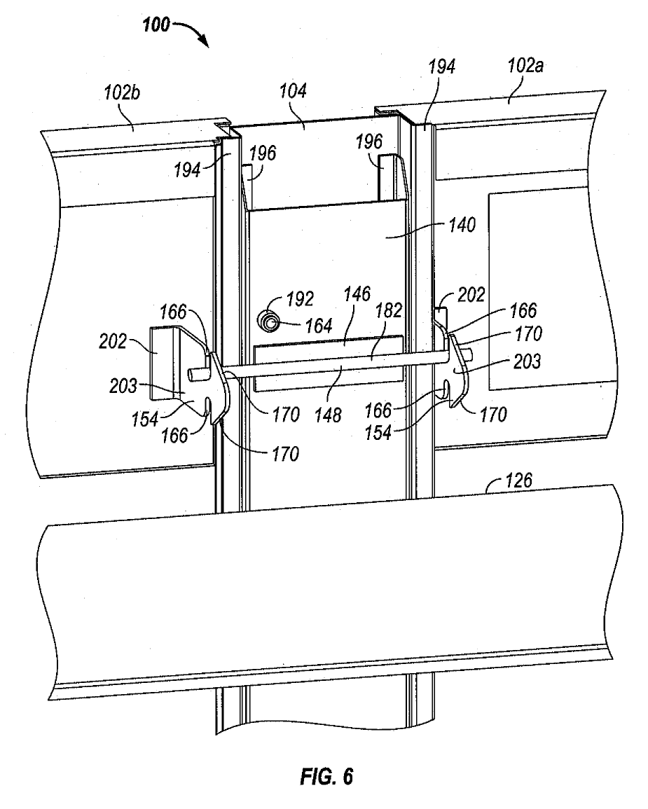

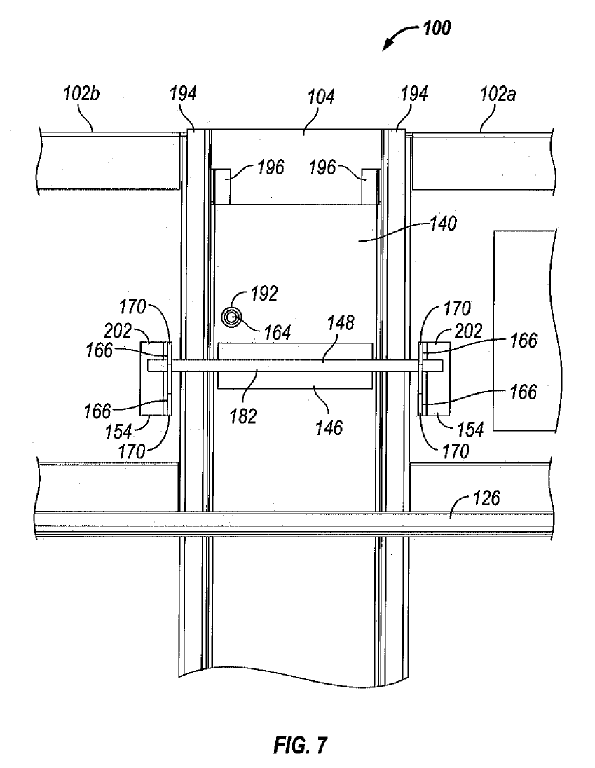

As shown in FIG. 6, each flange 154 is formed of metal and has an attachment portion 202 which is welded to the inner surface of the doors 102a, 102b and a finger 203 which extends perpendicularly from the attachment portion 202. A pair of slots 166 are provided in each finger 203. Each finger 203 has beveled surfaces 170 near their tips to promote entry of the locking bar 148 therein as described herein. One of the slots 166 extends from the upper edge thereof toward the bottom of the finger 203 but does not extend completely through the finger 203, and the other of the slots 166 extends from the lower edge thereof toward the top of the finger 203 but does not extend completely through the finger 203. The slots 166 are aligned.

The movable panel 140, spacer plates 146, locking bars 148, handle 152 and sleeve 192 are assembled together to form a subassembly that is then assembled with the remainder of the locking mechanism 120. Each of these components are preferably formed of metal. As shown in FIG. 6, the movable panel 140 is a generally U-shaped member that has tabs 196 that extend inwardly from its sides. The front and movable panels 104, 140 are sized and dimensioned such that the movable panel 140 fits within the U-shaped channel of the front panel 104 and is constrained on three sides, such that the movable panel 140 can move, typically in a sliding manner, upwardly or downwardly relative to the front panel 104. The spacer plates 146 are generally flat plates which are welded onto a rear face of the movable panel 140 at predetermined locations. The locking bars 148 are cylindrically-shaped with a rounded circumference 182 and are welded onto the spacer plates 146 at the proper locations to ensure that the locking bars 148 will engage with the slots 166 in the flanges 154. The ends of the locking bars 148 thus extend past the side edges of the movable panel 140 and the side edges of the spacer plates 146. It should be noted that the sole purpose of the spacer plates 146 is to position the locking bars 148 at the appropriate distance from the movable panel 140 so that the spacer plates 146 will properly engage the slots 166 of the flanges 154. As shown in FIG. 4, the handle 152 is welded to the front face of the movable panel 140 a predetermined distance from the top of the movable panel 140. As shown in FIG. 4, the sleeve 192, which has an aperture in its center, is inserted into an aperture through the movable panel 140, and is welded to the rear face of the movable panel 140 such that the sleeve 192 extends from the front face of the movable panel 140 an appropriate amount. The weld beads formed between the sleeve 192 and the movable panel 140 are located on the rear face of the movable panel 140 to make sure that there is no interference with other parts of the locking mechanism 120 that could prevent it from working.

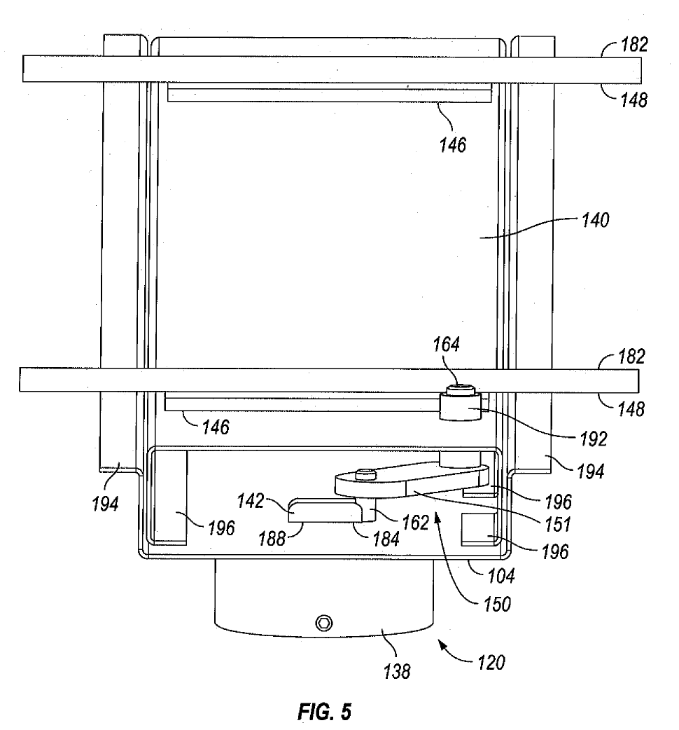

As best illustrated in FIG. 5, the pivot arm assembly 150 includes a pivot arm 151, an inwardly extending member 164 and an outwardly extending member 162. The inwardly and outwardly extending members 164, 162 are preferably bosses or the like. The pivot arm 151 is preferably an elongated flat bar with rounded ends. The inwardly extending member 164 extends from one of the rounded ends of the pivot arm 151 and the outwardly extending member 162 extends from the opposite rounded end of the pivot arm 151. The inwardly extending member 164 extends into the aperture in the sleeve 192. The outwardly extending member 162 extends through the elongated horizontal slot 184 in the front panel 104. As such, the pivot arm 151 is sandwiched between the front surface of the movable panel 140 and the rear surface of the front panel 104. The pivot arm 151 is rotatable relative to the movable panel 140 via the inwardly extending member 164 in the sleeve 192, and is rotatable relative to the front panel 104 via the outwardly extending member 162 in the elongated horizontal slot 184. The movement of the outwardly extending member 162 is constrained by the elongated horizontal slot 184.

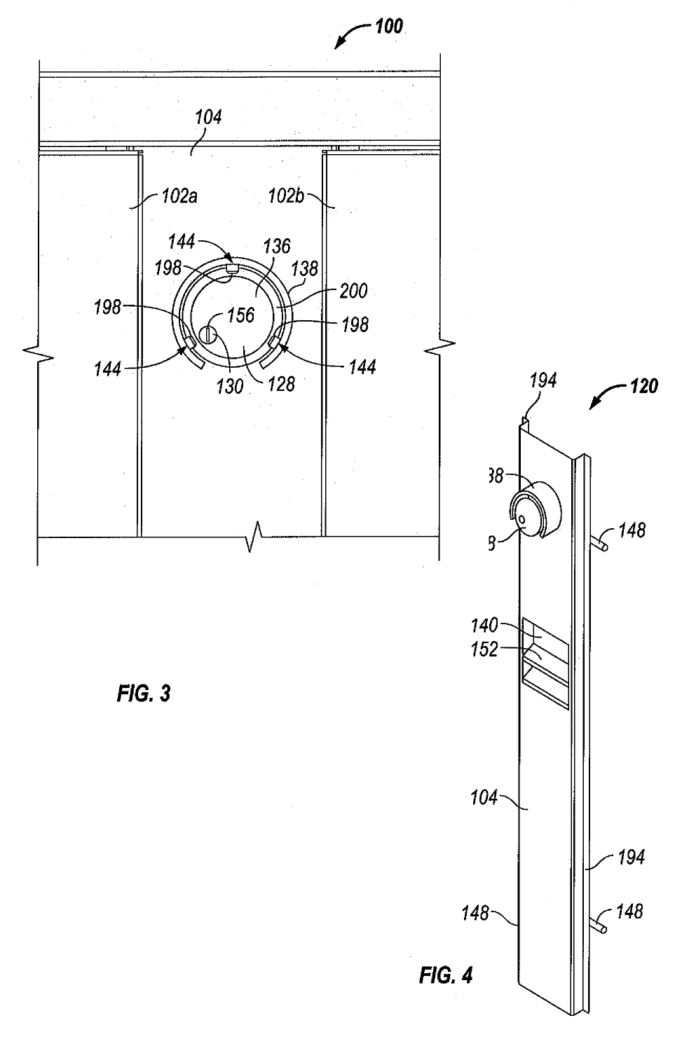

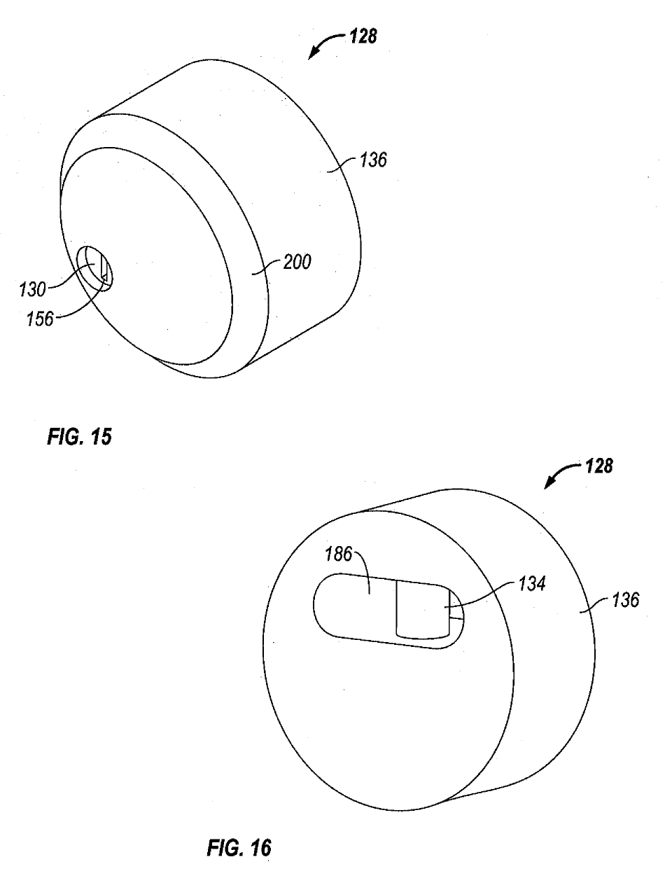

The lock 128 has a circular body 136 having a key tumbler 130 provided in the body 136 and an associated keyhole 156 located on the front face thereof, as illustrated in FIGS. 3 and 13-16. The lock 128 does not have an exposed shackle, and preferably is a puck lock. An elongated horizontal slot 186 extends from the back surface of the body 136 inwardly a predetermined distance. A spring-biased shank 134 (spring not shown) extends within a vertical passageway which is in communication with the slot 186. As shown in FIG. 14, the spring-biased shank 134 can extend from the body 136 when a key (not shown) within the keyhole 156 is turned a predetermined way, such that the shank 134 is withdrawn from the slot 186. As shown in FIG. 16, the spring-biased shank 134 can be retracted into the body 136 by pushing the shank 134 upwardly into the body 136, thereby overcoming the spring, until the shank 134 extends into the slot 186. The lock 128 preferably has a beveled surface 200 provided along the outside edge of the front face thereof. Preferably, the lock 128 is formed from hardened steel so that a thief cannot drill into the lock 128 and disable it. The lock 128 also does not have a shackle such that a thief cannot break the lock 128 by cutting a shackle with bolt cutters. This greatly enhances the overall security of the lock box 100.

As shown in FIG. 3, the skirt or housing 138 is mounted on the front face of the front panel 104 and surrounds the elongated horizontal slot 184. The shape of the skirt 138 conforms to the outer perimeter shape of the lock 128 such that it surrounds at least a portion of the perimeter of the lock 128. The skirt 138 does not extend into the space occupied by the shank 134 when the shank 134 extends outwardly, and preferably downwardly as illustrated, from the body 136. The skirt 138 is formed of metal and is welded to the front panel 104. The weld locations are provided on the outer surface of the skirt 138 to ensure that the weld beads do not interfere with the lock 128 being fully seated in the rear of the pocket formed by the annular skirt 138 and the front panel 104.

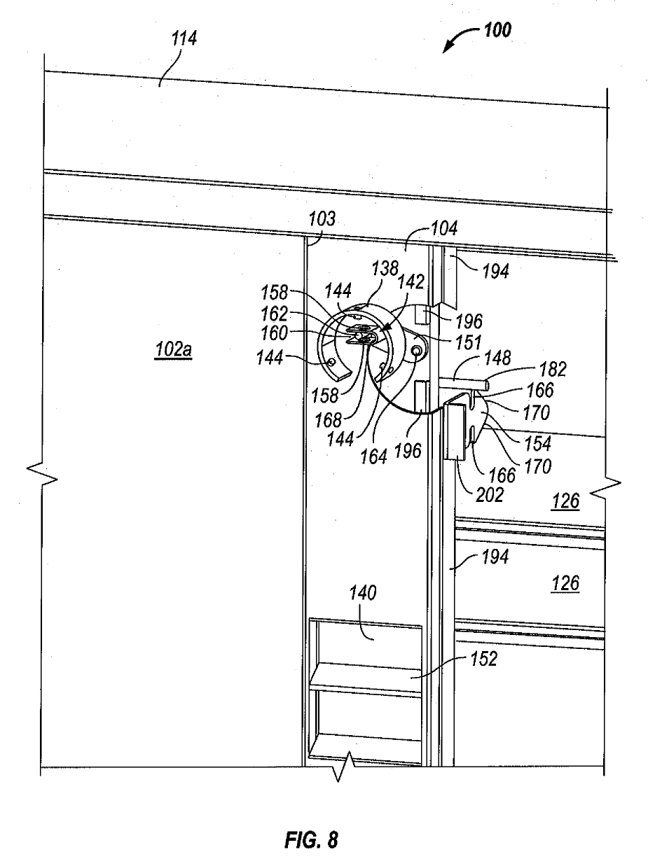

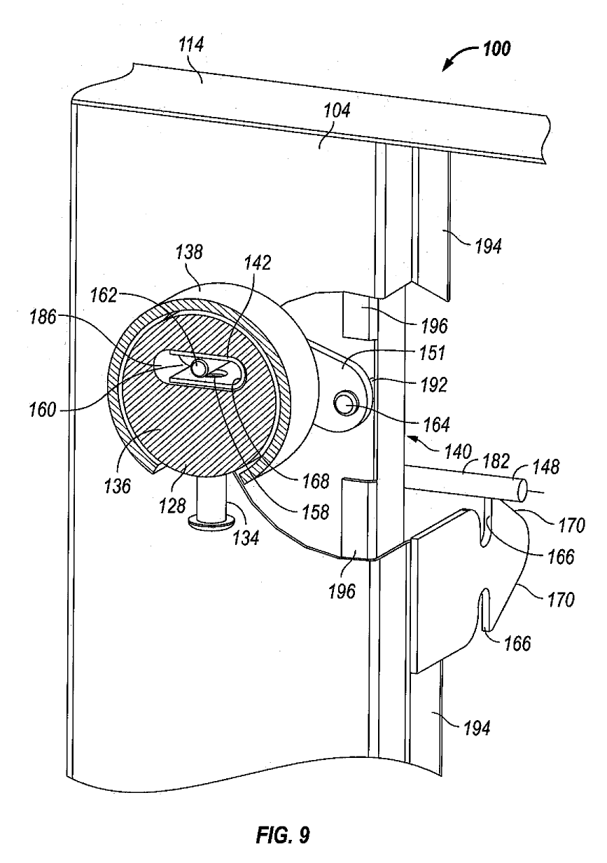

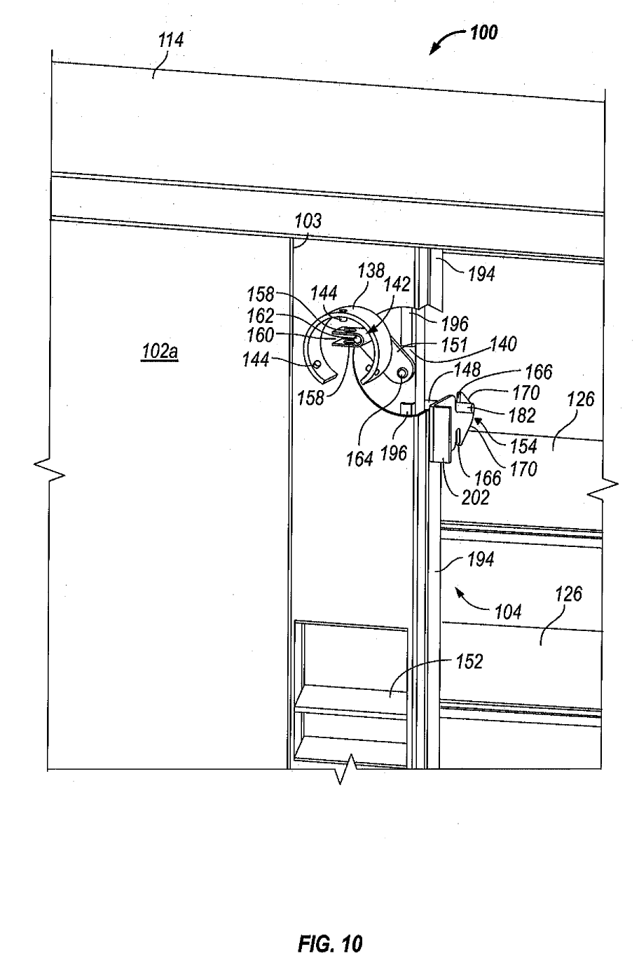

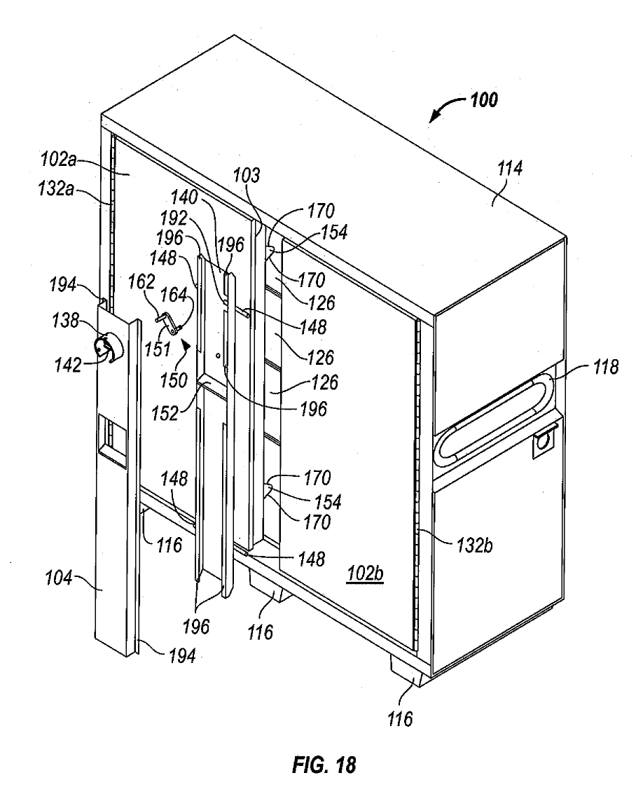

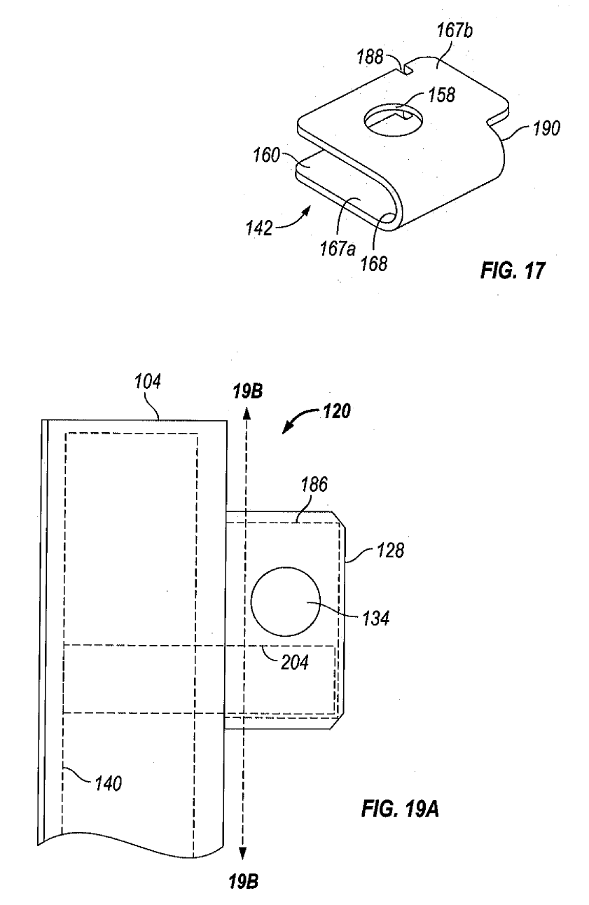

As best shown in FIG. 17, the U-shaped guide bracket 142 has lower and upper legs 167a, 167b connected together by an arcuate end 168. A slot 160 is defined between the legs 167a, 167b and the arcuate end 168. When mounted on the front face of the front panel 104, the legs 167a, 167b are perpendicular to an axis which runs parallel to the height of the front panel 104. Each leg 167a, 167b has an aperture 158 provided therethrough, which are aligned with each other. The U-shaped guide bracket 142 is shaped such that it can be seated within the slot 186 and the apertures 158 in the legs align with the passageway in which the spring-biased shank 134 is mounted, as best illustrated in FIGS. 9, 11 and 12. An inwardly stepped portion 190 is provided along the rear edge of the lower leg 167a, the arcuate end 168 and a portion of the upper leg 167b. Therefore, a portion of the upper leg 167b extends rearwardly of the remainder of the upper leg, the lower leg 167a and the arcuate end 168. A keyway 188 is provided at the free end of the upper leg 167b, proximate to the rear edge. The keyway 188 generally aligns with the stepped portion 190. As shown in FIG. 8, the metal U-shaped guide bracket 142 is mounted on the front panel 104 by welding, and is positioned within the skirt 138. The outwardly extending member 162 of the pivot arm assembly 150, which extends through elongated horizontal slot 184, seats within the slot 160 in the U-shaped guide bracket 142.

Once the user has placed all the items, such as tools, desired to be stored into the lock box 100, the user can then close the left and/or right door 102a, 102b by pushing onto the door(s) 102a, 102b causing them to rotate about their respective vertical hinges 132a, 132b. Eventually, the doors 102a, 102b will contact a portion of the locking mechanism 120, which in turn, causes the locking mechanism 120 to displace until the doors 102a, 102b bottom out onto the front panel 104 of the lock box 100. At this time, the locking mechanism 120 firmly retains the doors 102a, 102b in the closed configuration. The exact manner by which this is achieved is discussed herein. Finally, the user pushes up onto the exposed portion of the shank 134 of the lock 128, which extends below the body 136 of the lock 128, until the lock 128 is locked, preventing the locking mechanism 120 from disengaging either of the doors 102a, 102b. The lock box 100 is now locked, preventing anyone from opening the doors 102a, 102b and accessing the items contained therein.

When the lock box 100 is in this closed configuration as shown in FIG. 2, the shank 134 of the lock 128 is substantially inaccessible because it is completely enclosed within the body 136. This makes cutting of the shank 134 of the lock 128 impractical when it is in the locked configuration, greatly enhancing the overall security of the box lock 100. Furthermore, the user can then move the lock box 100 easily by lifting and pulling onto one of the side handles 118, until the lock box 100 slides on one of the skids 116. Alternatively, the lock box 100 can be lifted off the ground using lift rings 124, and moved to another desired location.

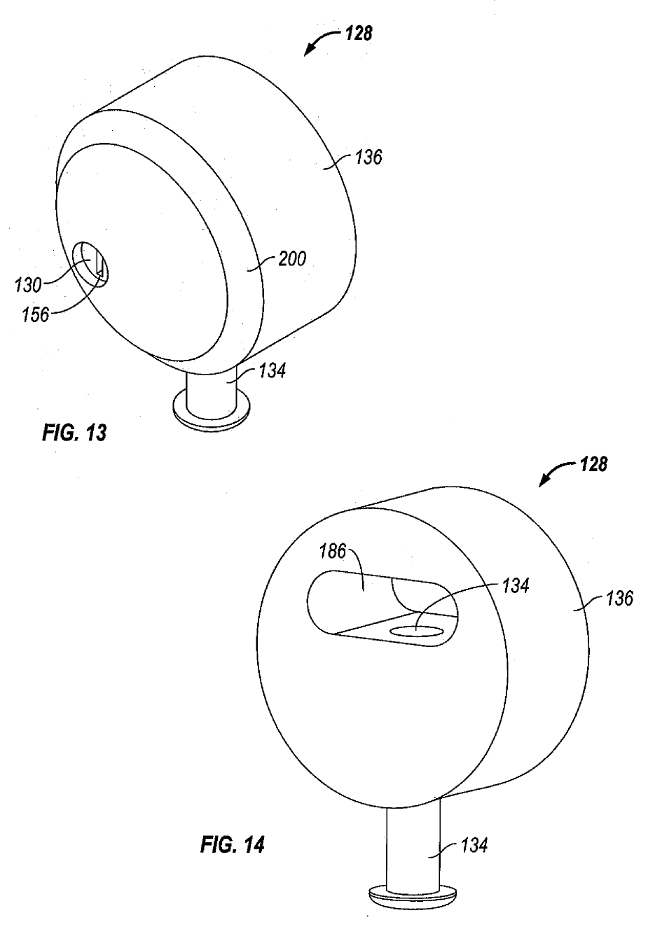

The open configuration of the locking mechanism 120 is effected in the following manner. First, the user unlocks the lock 128 by inserting a key into the keyhole 156. Then the user twists the key in the lock 128 which causes the spring-biased shank 134 of the lock 128 to move out of the apertures 158 in the U-shaped guide bracket 142. As a result, the slot 160 is not blocked by the shank 134. Therefore, when the lock 128 is in an unlocked position as shown by FIGS. 13 and 14, the outwardly extending member 162 of the pivot arm assembly 150 can move, preferably in a sliding manner, within the slot 160 in the U-shaped guide bracket 142, as illustrated in FIG. 9. The user can then move the handle 152 upward to its extreme upper position.

During the upper movement of the handle 152, the movable panel 140 which is fixedly attached to the handle 152, moves upward, in a sliding manner, while at the same time the pivot arm 151 begins to rotate about the inwardly extending member 164 which is rotatably attached to the movable panel 140. This motion causes the outwardly extending member 162 of the pivot arm assembly 150 to move, in a sliding manner, along the slot 160 in the U-shaped bracket 142 in a horizontal direction. This is possible only because the shank 134 of the lock 128 no longer obstructs this motion because it has dropped vertically as a result of the lock 128 being unlocked. The user continues moving the movable panel 140 upward until the ends of the locking bars 148 no longer engage the slots 166 in the flanges 154.

Once this open configuration of the locking mechanism 120 has been achieved, the user places his or her hand within the finger slot 103 in the door 102a, 102b, and pulls such that the door 102a, 102b rotates on its hinge 132a, 132b until it reaches a fully open position. It should be noted that the user does not need to remove the lock 128 from the lock box 100 to achieve a locking mechanism 120 that is in the open configuration. This prevents the user from pinching their fingers when taking the lock 128 off the lock box 100 and from potentially losing the lock 128. Now, the user can place items into or take items out of the lock box 100 with the door 102a, 102b open after the user has released the handle 152 which allows the movable panel 140 to fall down and the locking mechanism 120 to return to its naturally-biased position where the outwardly extending member 162 of the pivot arm assembly 150 rests within the slot 160 proximate to the arcuate end 168 of the U-shaped guide bracket 142.

Conversely, the closed configuration is effected in the following manner. First, the user pushes on the door 102a, 102b, causing the door 102a, 102b to rotate on its hinge 132a, 132b. Eventually, the locking bars 148 engage with the beveled surfaces 170 of the flanges 154. The user continues to push onto the door 102a, 102b, which begins to move the locking bars 148 upward as the locking bars 148 slide up the beveled surfaces 170 in a ramping motion, see FIGS. 8 and 9. It is preferable that the locking bar 148 have a rounded circumference 182 to minimize friction and facilitate this ramping motion. This process continues until the locking bars 148 ride over the top of the flange 154 and ride thereon until the locking bars 148 fall into the slots 166 on the fingers 203 under the force of gravity. Approximately simultaneously, the doors 102a, 102b bottom out on the front panel 104 of the lock box 100.

Alternatively, the user can lift up on the handle 152 until the locking bars 148 are above the flanges. 154 and push the door 102a, 102b until it bottoms out on the front panel 104. Next, the user can drop the handle 152, movable panel 140, and locking bars 148 down until the locking bars 148 engage the slots 166 of the fingers 203. At this point with either method, the doors 102a, 102b are in a latched configuration and cannot be opened without pulling up onto the handle 152 as described.

The last step in locking the lock box 100 includes having the user push up onto the shank 134 of the lock 128 until the lock 128 is activated and in a locked configuration. During this operation, the shank 134 of the lock 128 passes through the apertures 158 in the U-shaped guide bracket 142, making any removal of the lock 128 impractical. It is possible for the shank 134 to engage the apertures 158 of the guide bracket 142 because the outwardly extending member 162 of the pivot arm assembly 150 has been moved out of the way because the locking mechanism 120 has returned to its natural state as described above, namely where the outwardly extending member 162 is provided in the slot 160 between the apertures 158 and the arcuate end 168. If the locking mechanism 120 has not been returned to its natural state, the lock 128 cannot be locked because of the interference that will be created between the outwardly extending member 162 of the pivot arm assembly 150 and the shank 134 of the lock 128. Once the lock 128 is locked, the outwardly extending member 162 of the pivot arm assembly 150 is constrained on all sides and cannot move significantly. As a result, the movable panel 140, handle 152, and locking bars 148 cannot move upwardly because they are held in place by the inwardly extending member 164 of the pivot arm assembly 150. Thus, the locking bars 148 are seated within slots 166 of the flanges 154 until the lock 128 has been unlocked. Now the lock box 100 is in a locked configuration and the items contained therein cannot be accessed.

FIG. 18 shows how the locking mechanism 120 is assembled and attached to the lock box 100. First, the annular skirt 138 is welded onto the front face of the front panel 104 near its top portion where it is positioned appropriately with respect to the elongated horizontal slot 184 through the front panel 104. This is necessary because the annular skirt 138 aligns the body 136 of the lock 128 with the slot 184, and the guide bracket 142 must also fit within the slot 186 on the back of the body 136 of the lock 128, making sure that the orientation of the lock 128 is proper with the longitudinal axis of the slot 186 of the lock 128 pointing in a substantially horizontal direction.

Next, the guide bracket 142 is inserted partially through the front of the slot 184 on the front panel 104 until the edge of the front panel 104 enters into the keyway 188. Subsequently, the guide bracket 142 is rotated until its stepped portion 190 contacts the front panel 104. The portion of the guide bracket 142 rearwardly of the keyway 188 is then welded to the rear surface of the front panel 104 so that no weld beads will interfere with the insertion of the lock 128. The assembler now has a first subassembly, which includes the front panel 104, the annular skirt 138, and the U-shaped guide bracket 142, that eases the overall assembly of the locking mechanism 120.

The assembler then creates a second subassembly comprising the movable panel 140, sleeve 192, handle 152, spacer plates 146, and locking bars 148 in the following manner. First, the spacer plates 146 are welded onto the rear face of the movable panel 140 at the appropriate, predetermined places. Second, the locking bars 148 are welded onto the spacer plates 146 at the proper locations to ensure they will engage with the flanges 154 to allow the locking mechanism 120 to work properly. Third, the handle 152 is welded at a suitable place on the front surface of the movable panel 140. Fourth, the apertured sleeve 192 is inserted into the aperture in the movable panel 140 and is welded to the rear face of the movable panel 140 such that the sleeve 192 extends from the front face of the movable panel 140 an appropriate amount. These weld beads are located on the rear face to make sure that there is no interference with other parts of the locking mechanism 120 that could prevent it from working.

The locking mechanism 120 is assembled from the first subassembly, second subassembly, and the pivot arm assembly 150 in the following manner. After the assembler has inserted the inwardly extending member 164 of the pivot arm assembly 150 into the aperture in the sleeve 192, which provides enough surface area to make sure that the pivot arm 151 can rotate and will not bind, the second subassembly and the pivot arm assembly 150 are maneuvered until the outwardly extending member 162 of the pivot arm assembly 150 is seated within the slot 160 in the U-shaped guide bracket 142. The assembler continues to press the front and movable panels 104, 140 together until the inwardly extending tabs 196 of the movable panel 140 contact the rear face of the front panel 104, providing bearing surfaces which will allow the movable panel 140 to move, preferably in a sliding manner, relative to the front panel 104.

Now the entire locking mechanism can be moved to the lock box 100, providing that the assembler presses the front panel 104 and movable panel 140 together at all times. Once the locking mechanism 120 has been placed onto the frame of the lock box 100 in the desired location, the front panel 104 is welded onto the shelves 126, which holds the locking mechanism 120 permanently in place. From this point forward, the movable panel 140 can only move up and down and is limited in this movement only by the translation of the outwardly extending member 162 of the pivot arm assembly 150 and its interaction with the guide bracket 142 and other components of the locking mechanism 120 because its length is less than the length of the front panel 104. This makes sure that the locking bars 148 will always fully engage the flanges 154 that are attached to the interior of the doors 102a, 102b. The weight of the movable panel 140 moves the locking mechanism 120 back to its natural state with the outwardly facing boss 162 in its nested condition within the slot 160 proximate to the arcuate end 168 of the U-shaped guide bracket 142.

The last step in assembling the locking mechanism 120 is accomplished by placing the lock 128 within the annular skirt 138 with the U-shaped guide bracket 142 inserted into the slot 186 on the rear of the lock 128 such that the lock 128 is held in place in all directions, except in a direction that is substantially perpendicular to the front face of the front panel 104. The lock 128 is held within the annular skirt 138 by three set screws 144 that are appropriately positioned along the inner surface of the skirt 138, distal to the front face of the front panel 104, such that a chamfer 198 found near the tips of the set screws 144 will push against the beveled surface 200 of the front face of the lock 128. Now the apertures 158 of the U-shaped guide bracket 142 are aligned with the moving path of the shank 134 of the lock 128 and the locking mechanism 120 will work as described above. Obviously, this construction allows the lock 128 to be easily replaced by another lock 128 that is commercially available. Furthermore, it is contemplated that any lock, such as that described in U.S. Pat. No. 3,769,821 issued to Randel, or any type of padlock that does not have an exposed U-shaped shackle will suffice for the present invention.

The components of the locking assembly 120 are made using several techniques. The front and movable panels 104, 140 are made using a roller forming or other suitable sheet metal bending process. The flanges 154 are made using punching and braking techniques. The flanges 154 have slots 166 both on their top and bottom of the fingers 203 and an attachment portion 202 at their base. This shape makes the flanges 154 symmetrical. This allows the flanges 154 to be used with either the left or right doors 102a, 102b, which are also symmetrical. Using symmetrical parts reduces the number of parts of the lock box 100 and the cost for manufacturing. Finally, the pivot arm 151, locking bars 148, U-shaped guide bracket 142, and spacer plates 146 can be made using commonly known methods including sawing, milling, turning, and welding.

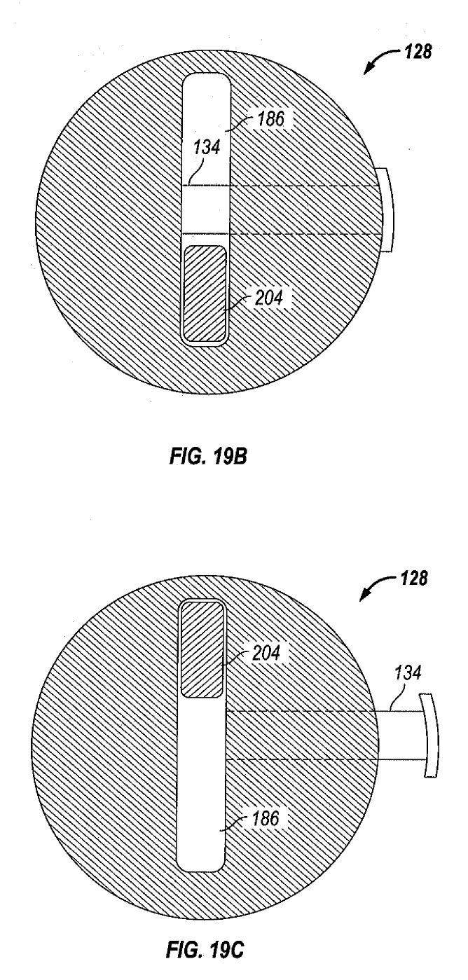

As can be seen, a lock box 100 is provided that is easy to organize, to take items out of or place items into, and that uses a lock 128 that cannot be easily tampered with or disabled. While this is the preferred technique because it provides a great deal of room to access the shank 134 of the lock 128 when it is unlocked, it is also contemplated that a similar result could be achieved by widening the front panel 104, rotating the lock 128 so that the longitudinal axis of the slot 186 of the lock 128 points vertically, and replacing the pivot arm assembly 150 with an outwardly extending member 204, such as a simple pin, that would translate up and down upon movement of the movable panel 140 as generally shown by FIGS. 19A-19C. When the lock 128 is in a locked configuration, the shank 134 will prevent the upward movement of the movable panel 140 and will keep the lock box 100 locked. On the other hand, when the lock 128 is unlocked, the shank 134 will be removed and the outwardly extending member 204 can slide freely and the lock box 100 can be unlocked in a similar fashion as was described for the preferred embodiment.

While preferred embodiments of the present invention are shown and described, it is envisioned that those skilled in the art may devise various modifications of the present invention without departing from the spirit and scope of the appended claims.

What is claimed is:

1. A lock box comprising:
at least one panel defining a cavity defining a cavity for receiving and storing items;
at least one door attached to said at least one wall which is configured to be movable between an open position which allows access into the cavity and a closed position which prevents access into the cavity; and
a locking mechanism that is operatively associated with said at least one door such that when said at least one door is in said closed position, said locking mechanism can be configured to lock said at least one door in said closed position, said locking mechanism including
a lock having a body and a shank, said body defining a slot which is open to an outward surface of said body, said shank configured to be movable within said body between a locked position where said shank is disposed within said slot and an unlocked position where said shank is not disposed within said slot,
a first movable member configured to be movable between a closed position where said first movable member is operatively engaged with said at least one door in order to keep said at least one door in said closed position, and an open position where said first movable member is operatively disengaged from said at least one door in order to allow said at least one door to be moved to said open position, said lock positioned relative to said first movable member such that said outward surface of said lock is proximate to said first movable member, and
a second movable member that is operatively associated with said first moveable member and that has a portion seated within said slot of said lock, wherein when said shank is in said locked position, said shank substantially prevents said second movable member from moving within said slot of said lock thus preventing said first movable member from moving from said closed position to said open position, and wherein when said shank is in said unlocked position, said second movable member is able to freely move within said slot of said lock thus allowing said first movable member to move from said closed position to said open position.

2. The lock box as defined in claim 1, wherein said lock is a puck lock.

3. The lock box as defined in claim 1, wherein said first movable member includes a locking bar and wherein said at least one door has a flange member extending therefrom, said flange member having at least one slot formed therein, wherein when said first movable member is in said closed position, said locking bar is positioned within said slot of said flange member in order to keep said at least one door in said closed position, and wherein during movement of said first movable member from said closed position to said open position, said locking bar is moved out of said slot of said flange member in order to allow said at least one door to be moved to said open position.

4. The lock box as defined in claim 1, further comprising a fixed panel having front and rear faces, said fixed panel attached to said at least one panel defining said cavity, said rear face of said fixed panel facing the cavity of the lock box, said first movable member configured to be movable between said closed position and said open position by way of a sliding engagement with said rear face of said fixed panel, said rear face of said lock abutting said front face of said fixed panel.

5. The lock box as defined in claim 4, further comprising a skirt secured to said front face of said fixed panel, said lock being at least partially positioned within and at least partially held in place on said front face of said fixed panel by said skirt.

6. The lock box as defined in claim 4, further comprising a guide bracket secured to said fixed panel, said guide bracket extending outwardly from said front face of said fixed panel, said guide bracket being positioned within said slot of said lock in order to properly position said lock relative to said fixed panel and to at least partially hold said lock in place, said guide bracket having at least one aperture provided therethrough such that said shank of said lock can extend through said aperture when said shank is in said locked position.

7. The lock box as defined in claim 6, wherein said guide bracket is U-shaped.

8. The lock box as defined in claim 4, wherein said fixed panel has an aperture provided therethrough and wherein said first movable member includes a handle extending through or being accessible through said aperture of said fixed panel in order to allow a user to manipulate said handle in order to move said first movable member between said closed position and said open position.

9. The lock box as defined in claim 1, wherein said at least one door is rotatably opened and closed about a vertical hinge.

10. The lock box as defined in claim 1, wherein said second movable member is configured to slide within said slot of said lock in a substantially perpendicular direction relative to a direction in which said first movable member is configured to move.

11. The lock box as defined in claim 10, wherein said second movable member is part of a pivot arm assembly which includes said second movable member, a pivot arm and a boss member, said second movable member extending outwardly from a first end of said pivot arm, said boss member extending outwardly from a second end of said pivot arm, said boss member being attached to said first movable member.

12. The lock box as defined in claim 11, wherein said first movable member has an apertured sleeve secured thereto, said boss member being configured to be positioned within said apertured sleeve.

13. The lock box as defined in claim 11, wherein said second movable member extends outwardly from said first end of said pivot arm in an opposite direction than said boss member extends outwardly from said second end of said pivot arm.

14. The lock box as defined in claim 1, wherein said shank of said lock is configured to move in a direction which is substantially parallel to a direction in which said first movable member is configured to move.

15. The lock box as defined in claim 1, wherein said shank of said lock is configured to move in a direction which is substantially perpendicular to a direction in which said first movable member is configured to move.
